(19) United States
(12) Patent Application Publication
(10) Pub. No.: US 2005/0011260 A1
(43) Pub. Date: Jan. 20, 2005

(54) Temperature sensing device for detecting an acceleration or shock provided with a heating unit, and associated method

(76) Inventors: Michael Arndt, Reutlingen (DE); Isolde Simon, Kusterdingen (DE); Bernhard Jakoby, Wien (AT)

Correspondence Address: KENYON & KENYON, ONE BROADWAY, NEW YORK, NY, 10004, US

(21) Appl. No.: 10/488,430

(22) PCT Filed: Feb. 19, 2003
(86) PCT No.: PCT/DE03/00502

(30) Foreign Application Priority Data
Jul. 5, 2002 (DE) 102 30 198.0

(51) Int. Cl. G01F 1/68

(52) U.S. Cl. 73/204.26

(57) ABSTRACT

A sensor is used for measuring the motion of a fluid in relation to a heating device. A temperature-measuring means is provided in such a way that the temperature of the fluid is measured at a measuring location as a function of the motion of the fluid, as a measuring location, the location of the heating device or its immediate vicinity being provided.

### FIELD OF THE INVENTION

The present invention is directed to a sensor having a heating device.

### BACKGROUND INFORMATION

To detect an impact, e.g., when an object strikes a motor vehicle, it is conventional to use acceleration sensors mounted in the motor vehicle. For the most part, these sensors evaluate the motion of a seismic mass. Also conventional, however, are sensors based on thermal operating principles. For example, such a known sensor has a trench that is spanned in the transverse direction by freely suspended bridges. One of these bridges is used as a heating element, while two adjacent bridges function as temperature sensors. The heating produces a temperature gradient, going out from the heating element in the direction of the temperature sensors. A sudden acceleration of the sensor changes the temperature gradient. Such known thermal acceleration sensors are relatively rugged, since, in contrast to sensors having a seismic mass, they do not include any movable parts. However, this rugged quality is limited by the fine, freely suspended bridges. They are especially vulnerable to particles present in the ambient environment of the freely suspended bridges, thus, for example, in the air. Moreover, they are expensive to manufacture, since, for example, conventional sawing process are impossible or difficult to use for these sensors.

### SUMMARY

A sensor according to an example embodiment of the present invention and the method according to the present invention may have the advantage that a simpler, more rugged sensor and an evaluation method or a measurement method are provided. In addition, it may be advantageous that the heating device and the temperature measuring means are provided at one and the same location, i.e., in the immediate vicinity of one another. This enhances the stability and, respectively, the ruggedness of the sensor system.

In contrast to conventional sensors, in the design according to the present invention of a thermal impact and acceleration sensor, there is no dependence of the output signal on the inclination of the sensor. Moreover, the output signal is independent of the direction in which the acceleration takes place.

It is furthermore advantageous if the electrical resistance of the heating device and a wiring of the heating device are provided as temperature-measuring means. Thus, in accordance with the present invention, it is possible for the heating device to implement both the function of heating, as well as that of temperature measurement. This makes the sensor system of the present invention simpler and less expensive to manufacture, so that it may be provided as a more rugged sensor at an equivalent price.

It is also advantageous if the heating device is provided for operation at a constant current, a constant voltage, or a constant power, the current, the voltage or the power being provided, in particular, as a function of a signal of an ambient-temperature sensor. The sensor system of the present invention is, therefore, able to be designed to compensate for measuring sensitivity over a broad ambient temperature range.

It may also be advantageous if a thermocouple is provided at the location of the heating device or in its immediate vicinity. In this way, it is possible to provide a measurement of the temperature of the fluid that is independent of the electrical resistance of the heating device.

Furthermore, it may be advantageous if a plurality of heating devices and a plurality of temperature-measuring means are provided. In this way, on the basis of the comparison of the time characteristic of the temperatures measured using the temperature-measuring means, it is possible to deduce the direction of impact. In one arrangement of a plurality of heating devices and their wiring configuration in the form of a Wheatstone bridge, one variant of the sensor system of the present invention is also able to provide an augmented output signal. In addition, when working with a plurality of heating devices, on the basis of the temporal location of the signals and the amplitudes, it is possible to measure the direction and the intensity of impact.

### BRIEF DESCRIPTION OF THE DRAWINGS

Exemplary embodiments of the present invention are illustrated in the drawings and are explained in greater detail in the following description.

FIG. 1 shows a conventional system.

FIG. 2 shows a first example embodiment of the sensor system according to the present invention in a perspective and in a sectional view.

FIG. 3 shows a sensor system according to the present invention, including a first variant of the heating device.

FIG. 4 shows a the sensor system according to the present invention, including a second variant of the heating device.

FIG. 5 shows a second example embodiment of the sensor system according to the present invention, in a plan view.

FIG. 6 shows a third example embodiment of the sensor system according to the present invention, in a plan view.

FIG. 7 shows a block diagram of an evaluation electronics for the first example embodiment of the sensor system according to the present invention.

FIG. 8 shows one possible implementation of a part of the evaluation circuit.

FIG. 9 shows a block diagram of an evaluation electronics for the second example embodiment of the sensor system according to the present invention.

FIG. 10 shows a block diagram of an evaluation electronics for the third example embodiment of the sensor system according to the present invention.

FIG. 11 shows a representation as a function of the time of the useful signal of a sensor system according to the present invention, given a lighter impact.

FIG. 12 shows a representation as a function of the time of the useful signal of a sensor system according to the present invention, given a heavier impact.

FIG. 13 shows another design variant of the sensor system according to the present invention.

FIG. 14 shows a fourth specific embodiment of the sensor system according to the present invention.

FIG. 15 shows a fifth example embodiment of the sensor system according to the present invention.

FIG. 16 shows four representations as a function of the time of the useful signals in accordance with the fourth example embodiment of the sensor system according to the present invention.

### DESCRIPTION OF EXAMPLE EMBODIMENTS

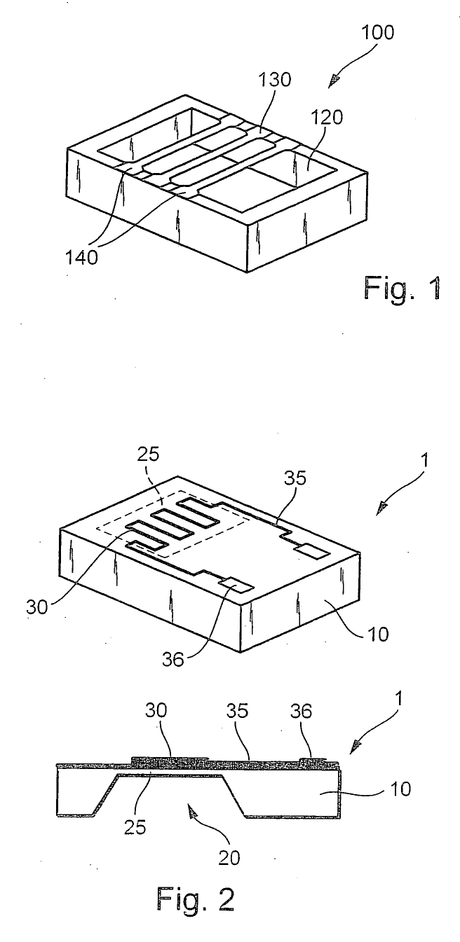

FIG. 1 shows illustratively a conventional sensor for detecting an impact, e.g., when an object strikes a motor vehicle, in accordance with the related art. The conventional sensor is provided with reference numeral 100. Sensor 100 includes a trench 120 which is spanned in the transverse direction by extremely fine, freely suspended bridges. These are denoted in FIG. 1 by reference numerals 130 and 140. One of these bridges is used as a heating element 130, while adjacent bridges 140 function as temperature sensors. As a result of the heating, a temperature gradient forms, starting from heating element 130, in the direction of the temperature sensors. A sudden acceleration of the sensor, for example due to an impact, effects a change in the temperature gradient. This change is detected via temperature sensors 140 and is converted by an evaluation electronics into an output signal proportional to the acceleration. The disadvantage of this system is that the fine, freely suspended bridges 130, 140 are not very rugged. These bridges are susceptible to particles found in the air or in the medium surrounding the bridges. Moreover, they are expensive to manufacture, since, for example, it is not possible to use a conventional sawing process when working with these sensors.

FIG. 2 shows a sensor 1 or a sensor system 1 according to an example embodiment of the present invention, in a perspective view in the top part of the figure and in a sectional view in the bottom part of the figure. Sensor 1 is implemented in a substrate 10 which is provided, in particular, as semiconductor substrate 10. For example, substrate 10 is also referred to in the following as silicon substrate 10. However, another semiconductor material may also be used as a substrate, or a material which is not a semiconductor may also be used as a substrate. Provided in substrate 10 of sensor 1 is a cavity formation 20 which is visible in FIG. 2, in the sectional view in the bottom part of the figure. Cavity 20 is able to be produced, for example, from the rear side of substrate 10 using bulk micromechanical technology. After cavity 20 is produced in substrate 10, a diaphragm 25 remains on the front side of substrate 10. Cavity 20 is formed in accordance with the example embodiment of the present invention, in particular, by etching of cavity 20 into silicon substrate 10. Cavity 20 is sealed off on the front side of substrate 10 by diaphragm 25 which has dielectric properties and is thermally insulating. At least one temperature-dependent resistor 30, for example of platinum, is situated on diaphragm 25. Other example embodiments of sensor system 1 of the present invention also provide, in addition to temperature-dependent resistor 30, other resistors or a thermocouple on diaphragm 25. In the example embodiments of the present invention, diaphragm 25, together with the structures situated thereon, has a small thermal mass and, thus, a low thermal time constant. Thus, it is possible to provide sensor systems 1 which have a time constant in the range of 5 milliseconds up to 15 milliseconds. In operation, resistor 30 or, given a plurality of resistors, at least one of these resistors is electrically heated. If sensor 1 is at rest, i.e., if no acceleration forces act on the sensor, then a narrowly limited volume of heated gas, such as air, or a convection current of the gas forms above and below electrically heated resistor 30. The temperature of resistor 30 and thus its resistance value adjusts to a constant value. If the sensor is accelerated and, in the process, undergoes a large enough deflection path amplitude, for example due to a jerky or impact-type lateral motion, then the inertia of the cold air in the ambient environment of the heated air volume, i.e., generally of the fluid volume, causes the heated volume to move away from the sensor, i.e., in this case, away from the location of the temperature measurement. Due to the low time constant of diaphragm 25, resistor 30 cools off accordingly. This leads to a change in the resistance value of resistor 30 which may be detected using an evaluation device or an evaluation electronics. The evaluation electronics includes means for heating resistor 30 and means for measuring the resistance value of resistor 30 and for converting the same into an electrical useful signal. Sensor 1 and the evaluation electronics may be used for detecting suddenly occurring impacts. The signal amplitude of the useful signal is dependent on the intensity of the impact. For that reason, sensor 1 may also be used for an acceleration measurement. In accordance with the present invention, it is useful when the deflection amplitude of the impact is great enough, for example, a few millimeters, to enable resistor 30 to move away from under the heated gas volume and, thus, “see” a different temperature. It is also clear, however, that the minimum amplitude of the impact with regard to the deflection path becomes all the smaller, the smaller the dimensions of resistor 30 or of cavity 20 and of the entire sensor system 1 are.

Sensor system 1 according to the present invention has a rugged design and may be manufactured using standard processes. Since there is no need for seismic masses, which could strike against a stop means in response to a heavy impact, such a sensor according to the present invention may be used to measure large impact-intensity ranges without potentially damaging sensitive movable parts in sensor 1.

In this context, sensor 1 is based on the principle that resistor 30 is provided as heating device 30. Heating device 30 is in thermal contact with a fluid, in particular a gas, which is contained in cavity 20 or is also situated on the top side of diaphragm 25. Without the influence of an accelerating force acting on sensor 1, the heating action of heating device 30 results in a thermal equilibrium in the form of a constant heat flow from heating device 30 into the fluid. If sensor system 1, together with its heating device 30, is subjected to an accelerating force, then the inertia of the fluid results in a motion of the fluid relative to heating device 30, thereby changing the thermal equilibrium, which leads to a temperature change at the location of the heating device or in its immediate vicinity. In accordance with the present invention, at the location of heating device 30 or in its immediate vicinity, a temperature-measuring means is provided, which is able to detect the change in the thermal equilibrium on the basis of a temperature change. As a result, the motion of the fluid in relation to heating device 30 is measurable. In a first and second example embodiment of sensor 1, the present invention provides for the electrical resistance value of heating device 30 to be used as a temperature-measuring means. A third example embodiment of sensor 1 provides for a temperature-measuring means that is separate from heating device 30.

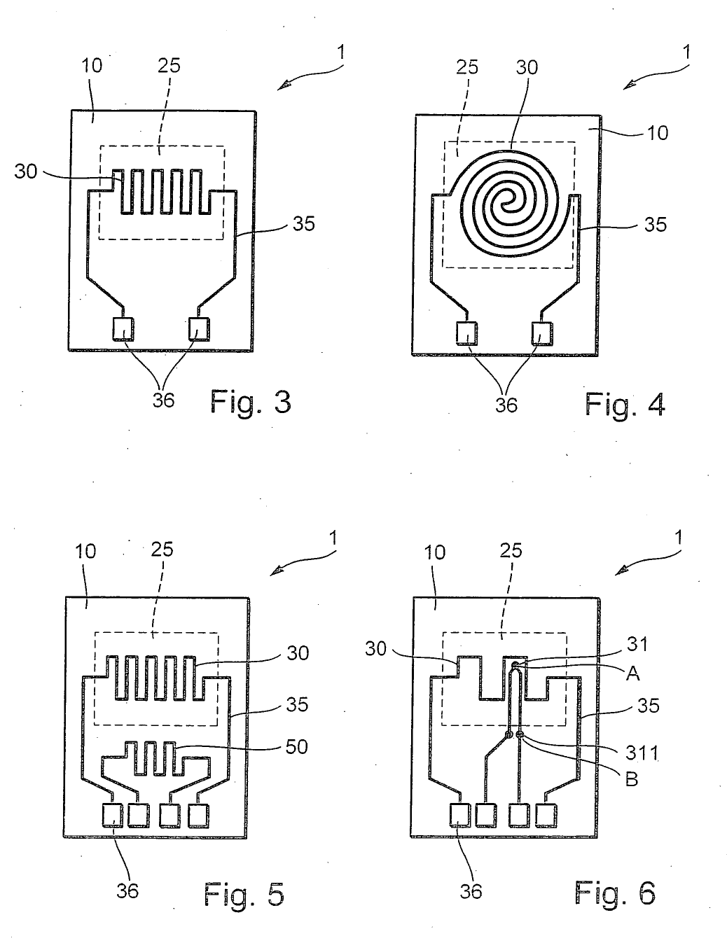

In accordance with various example embodiments of the present invention, thermally insulating diaphragm 25, in particular of silicon oxide and silicon nitride, is provided over cavity 20. The formation of diaphragm 25 in the silicon oxide and silicon nitride is especially useful in accordance with the present invention when silicon is used as substrate 10. A heating device 30 or a plurality of heating devices 30, which may be differently formed, are located on diaphragm 25. A first variant of the form of heating device 30 in a meander shape is shown in FIG. 3, and a second variant of the form of heating device 30 in a helical shape is shown in FIG. 4. Both in FIG. 2 as well as in FIGS. 3 and 4, resistor 30 or heating device 30 is electrically connectible to connection surfaces and bonding pads (reference numeral 36) and to leads 35. Bonding pads 36 and leads 35 are provided on substrate 10. Resistor 30 is provided, in particular, of platinum.

FIG. 5 shows a second example embodiment of sensor 1 according to the present invention. Besides heating device 30 in the region of diaphragm 25, in the second example embodiment, an ambient-temperature sensor 50 is provided on substrate 10 and is likewise connectible via bonding pads and leads, which, however, are not denoted by reference numerals. In accordance with the present invention, ambient-temperature sensor 50 is likewise provided of platinum, in particular. Ambient-temperature sensor 50 is provided for detecting the ambient temperature. The resistance value of the ambient-temperature sensor may be used to compensate for the measuring sensitivity of the temperature-measuring means according to the present invention over a broad ambient-temperature range.

FIG. 6 shows a third example embodiment of sensor system 1 according to the present invention. In contrast to the first example embodiment, a thermocouple 31 that is separate from heating device 30 is provided. It measures the temperature of the fluid at the location of the heating device or in its immediate vicinity. Thermocouple 31 is designed as a temperature sensor and is linked via special leads 311 on substrate 10 to bonding pads which are not denoted by reference numerals. In accordance with the present invention, the third example embodiment provides for thermocouple 31 directly at the location of heating device 30 or in its immediate vicinity. In this connection—for the case of a meander shape of heating device 30 on diaphragm 25—the location of heating device 30 is understood to be the entire diaphragm surface which is more or less covered by the meander structure of heating device 30. Even when thermocouple 31 is provided next to a resistance line of heating element 30, but within a loop of the meander-shaped structure of heating device 30, it is nevertheless positioned at the location of heating device 30, since even when heating device 30 is used as temperature-measuring means, no better spatial resolution would be possible with respect to temperature detection.

At its tip, thermocouple 31 includes a hot connection (letter A in FIG. 6) and, at its connection to leads 311 (letter B in FIG. 6), a cold connection. In a third embodiment of sensor system 1 of the present invention, it is also possible, of course, to provide a plurality of thermocouples 31 at the location of heating device 30 or in its immediate vicinity.

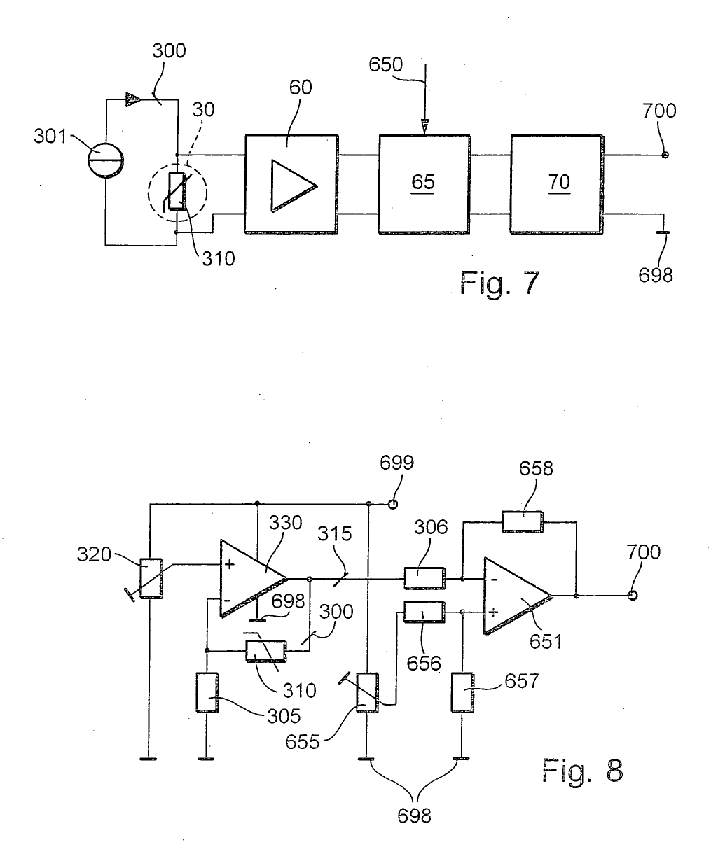

A block diagram of the evaluation electronics for the first embodiment of sensor 1 according to the present invention is illustrated in FIG. 7. It is provided in accordance with the present invention that the heating resistor provided as heating device 30 is operated on diaphragm 25 using a constant current or a constant voltage or a constant power. This is illustrated in FIG. 7 for the case of a constant current. The heating current is denoted in FIG. 7 by reference numeral 300. The resistance value of heating device 30 is denoted in FIG. 7 by reference numeral 310. To generate constant heating current 300, a constant current source 301 is provided in accordance with the present invention. Heating resistance 310 is measured using the voltage drop across it as a basis, and fed to an amplifier circuit 60. Following amplification in amplifier circuit 60, an offset correction is made in an offset-correction device 65 using an offset-correction voltage 650, and the signal is subsequently filtered in a filter device 70. From filter device 70, useful signal 700 is then able to be picked up in comparison to ground 698.

One possible implementation of the evaluation circuit of FIG. 7 is shown in FIG. 8, filter device 70 having been omitted, however. A first operational amplifier 330, which is connected to supply voltage 699 and ground potential 698, is used for adjusting constant heating current 300 through heating resistor 310, which is switched between the output of first operational amplifier 330 and its inverting input. The non-inverting input of the first operational amplifier is connected to the tapping point of a first controllable resistor 320, which is used for adjusting heating current 300. In addition, a first resistor 305 is arranged between mass 698 and the inverting input of first operational amplifier 330. Output signal 315 of first operational amplifier 330 is amplified by a second operational amplifier 651 and offset-compensated. For this, the output of first operational amplifier 330 is linked via a second resistor 306 to the inverting input of second operational amplifier 651. The output of second operational amplifier 651 is additionally linked via a third resistor 658 to the inverting input of second operational amplifier 651. Thus, second operational amplifier 651 is used as amplifier 60. In addition, a second controllable resistor 655 is connected between supply voltage 699 and ground potential 698, the tapping point of second controllable resistor 655 being connected via a fourth resistor 656 to the non-inverting input of second operational amplifier 651. Furthermore, the non-inverting input of second operational amplifier 651 is linked via a fifth resistor 657 to ground potential 698. An offset compensation is implemented by the described system at the non-inverting input of second operational amplifier 651. Thus, second operational amplifier 651 also corresponds partially to offset compensation device 65 from FIG. 7. At the output of second operational amplifier 651, (unfiltered) useful signal 700 is adapted to be tapped off.

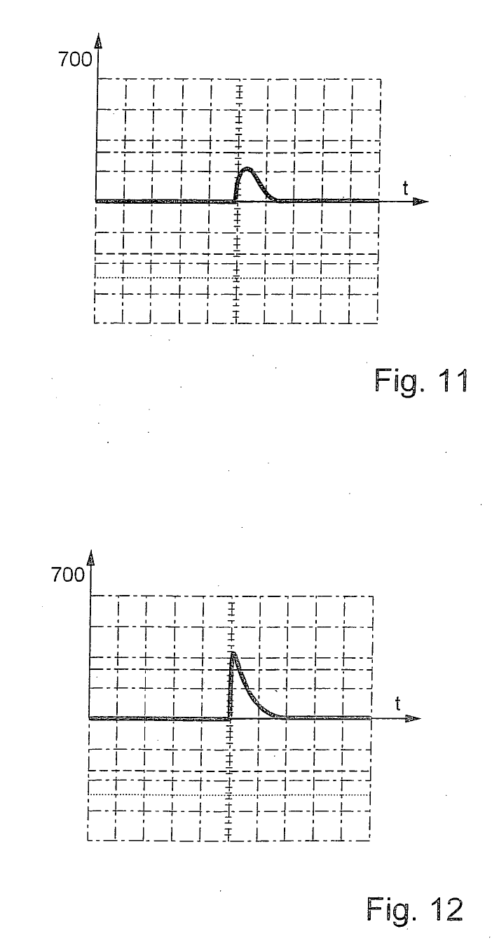

FIGS. 11 and 12 show representations of the time characteristic of useful signal 700 at the output of an evaluation circuit in accordance with FIG. 8 for the case that an impact is exerted on sensor system 1 in the middle of the time characteristic shown. The signal illustrated in FIG. 11 indicates a lighter impact, and the signal illustrated in FIG. 12 indicates a heavier impact.

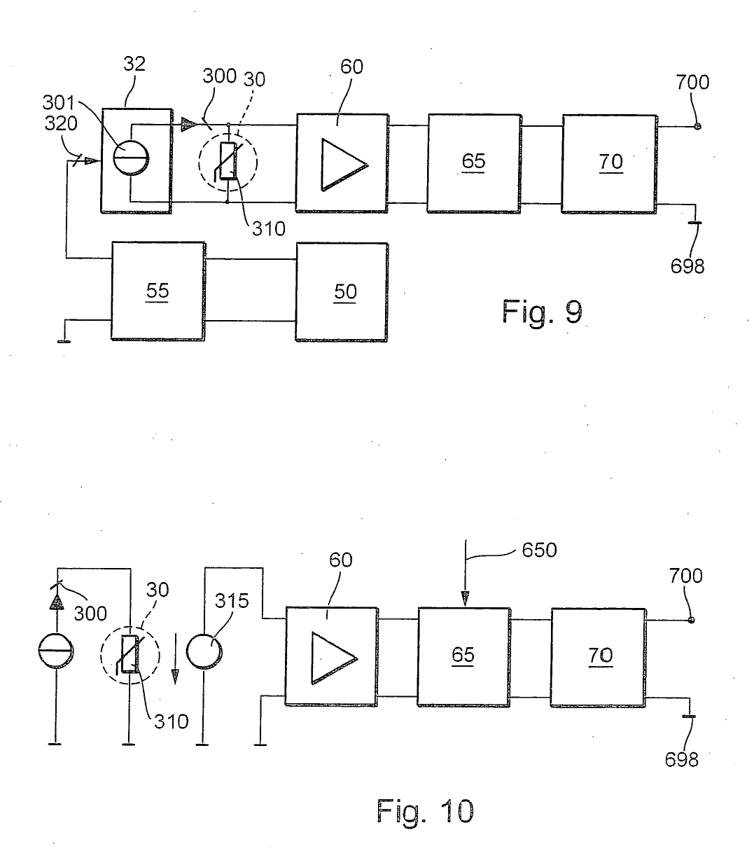

A block diagram of the evaluation electronics for the second example embodiment of sensor system 1 according to the present invention is illustrated in FIG. 9. The evaluation electronics for the second embodiment of the sensor system of the present invention also includes an amplifier device 60, an offset-compensation device 65, in FIG. 9, however, offset-compensation voltage 650 not being shown for the sake of simplicity, as well as a filter device 70, at whose output, useful signal 700 is present in comparison to ground 698. In contrast to the first embodiment, it is provided, however, in the second example embodiment of sensor system 1 of the present invention for heating current 300 to be regulated by heating device 30 as a function of the ambient temperature. For this, the second example embodiment provides for an ambient-temperature sensor 50, which is linked in FIG. 9 to a measuring transducer 55, which converts the signal of ambient-temperature sensor 50 into a control signal 320 used for adapting heating current 300 to the particular ambient temperature. To this end, control signal 320 is fed to a heating-current regulator 32 which regulates heating current 300 flowing through heating device 30 as a function of control signal 320. In the process, control signal 320 acts, in particular, on controllable constant current source 301. Control signal 320 is a signal generated by the measuring transducer and the ambient-temperature sensor which adapts the heating of the sensor element in such a way that the impact sensitivity remains constant within a broad ambient-temperature range. It is worth noting in the second example embodiment of sensor system 1 of the present invention that heating current 300 is still constant with regard to the time scales relevant to the detection of the state of motion of sensor system 1, even when it is regulated as a function of the ambient temperature. It is, namely, the case that the time constants for varying the ambient temperature and, thus, also the time constants for adjusting or changing heating current 300 are much longer or greater than the time constants for detecting a motion of the fluid in relation to heating element 30 according to the present invention. For that reason, heating current 300 may also be regarded as constant in the second example embodiment of the present invention with regard to measuring the motion of the fluid.

An evaluation electronics for use with the third example embodiment of the sensor system according to the present invention is illustrated in FIG. 10. Heating current 300 flows, in turn, through heating device 30, and resistance value 310 of heating device 30 is dependent on the temperature of the fluid. Because of the indirect coupling between heating device 30 and the temperature-measuring means in the form of a thermocouple 31, the third example embodiment of the sensor system of the present invention provides that, as an input of the evaluation electronics, temperature signal 315 is used, which is amplified in an amplifier device 60, is corrected with respect to offset in an offset-compensation device 65 by an offset compensation voltage 650, and is filtered in a filter device 70 in order to generate useful signal 700. In the third example embodiment of the sensor system of the present invention, the evaluation electronics is also provided in such a way that heating device 30 is operated with a constant heating current 300, i.e., alternatively with a constant voltage or a constant power. Thermocouple 31 always supplies a temperature-dependent voltage 315 as temperature signal 315. For output signal or useful signal 700 to be generated, temperature-dependent voltage 315 is amplified, offset-corrected, and filtered.

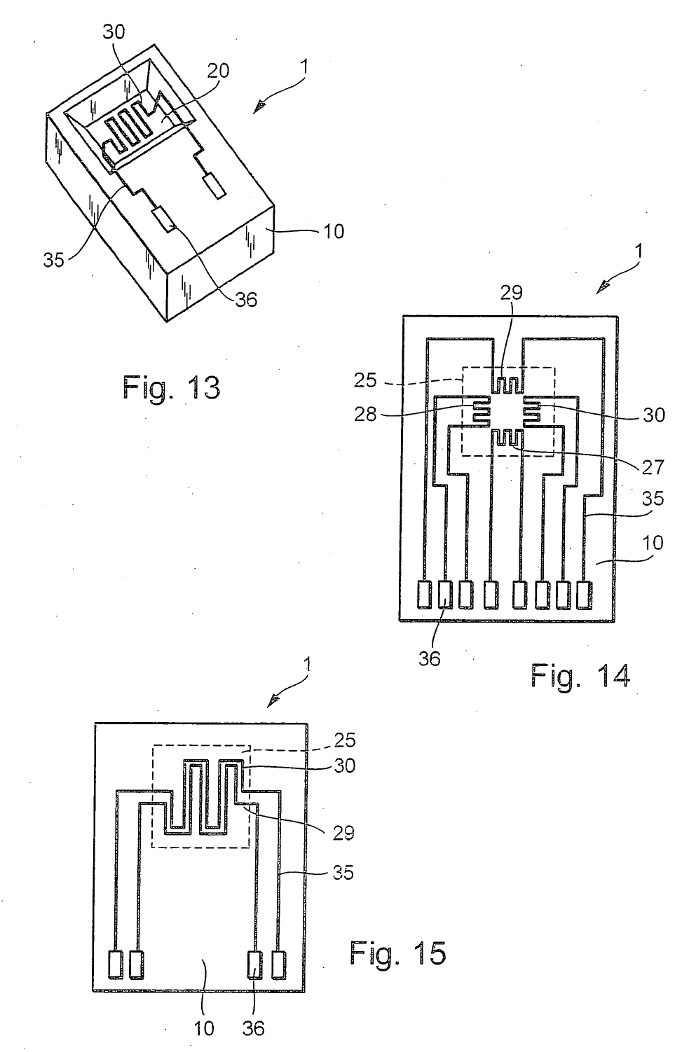

FIG. 13 shows another design variant of sensor system 1 according to the present invention in a perspective view. Here, a cavity 20 is provided in a substrate 10, a heating device 30 being in thermal contact with the fluid contained, in particular, in cavity 20. In another design variant of sensor system 1 of the present invention, a diaphragm between heating device 30 and the cavity is not provided. Sensor 1 may thus be made up of a substrate 10 or silicon substrate 10, into which cavity 20 is etched in such a way that, freely suspended over cavity 20, a temperature-resistant resistor remains as a heating device 30 in a meander or helical shape. In this way, the thermal mass of resistor 30 is reduced as compared to the first, second, and third example embodiments of the sensor system of the invention, which include a diaphragm 25. The omission of the diaphragm leads to a low thermal time constant and, thus, to a greater sensitivity of sensor 1. FIG. 13, as in the preceding figures as well, shows a bonding pad 36 and a lead 35 for heating device 35.

FIG. 14 is a fourth example embodiment of sensor system 1 according to the present invention, a substrate 10 and a diaphragm 25 being provided, in turn, a plurality of heating devices 30, 29, 28, 27 being provided on diaphragm 25 in the fourth embodiment of sensor system 1 of the present invention. Each of heating devices 27 through 30 has two bonding pads and corresponding leads for their electrical connection. For first heating device 30, this is shown exemplarily by bonding pad 36 and by connection line 35 in FIG. 14. In the fourth example embodiment of the sensor system of the present invention, it is possible, by comparing the time characteristic of the resistance values of heating devices 27 through 30, to infer the impact direction. For this, it is necessary that each of heating devices 27 through 30 be connected to an evaluation electronics in accordance with the first or second specific embodiment. Then, on the basis of the temporal location of the signals of various heating devices 27 through 30 and their amplitudes, the impact direction and the impact intensity may be measured.

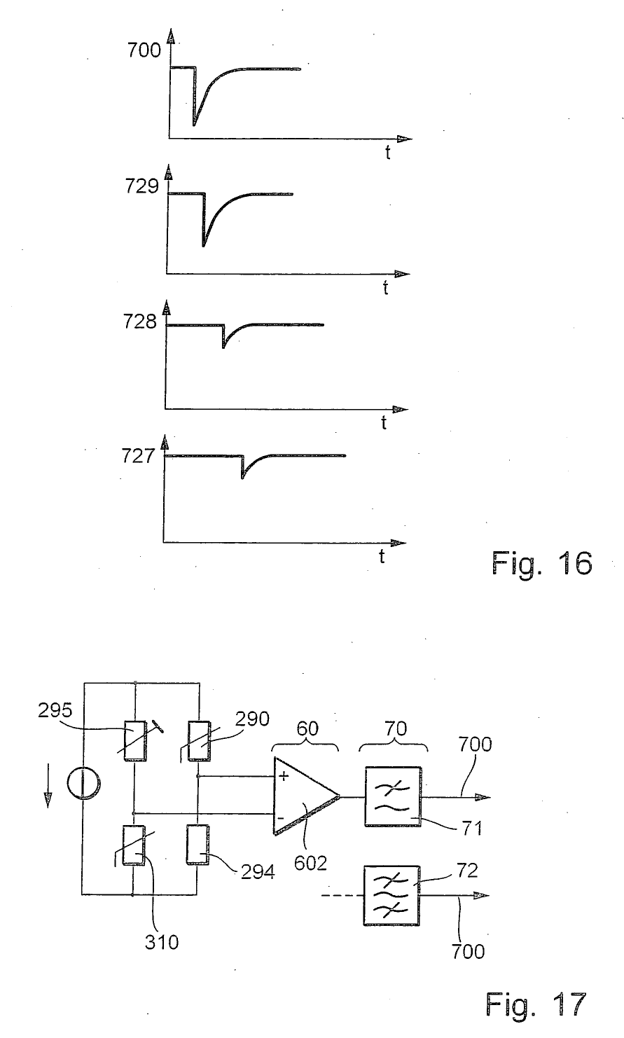

By way of example, FIG. 16 shows four representations of the time characteristic of the useful signals of the evaluation electronics assigned to heating devices 27 through 30, but not shown. In this connection, in the first representation, useful signal 700 of heating device 30 is shown. In the second representation in FIG. 16, useful signal 729 of the first further heating device 29 is shown. In the third representation, useful signal 728 of the second further heating device 28 is shown. In the fourth representation, useful signal 727 of the third further heating device 27 is shown. The signals illustrated in FIG. 16 correspond, in principle, to the signals illustrated in FIGS. 11 and 12, a change in operational sign having been made, however. In this sequence, signals 700, 729, 728, 727 have a certain time interval. In addition, signals 700 and 729 have a greater amplitude than signals 728 and 727. From the temporal position of signals 700, 729, 728, and 727 with respect to one another and the pulse level or the signal amplitude, inferences may be made with regard to the impact direction and impact intensity.

FIG. 15 shows a fifth example embodiment of sensor design 1 according to the present invention. Heating device 30 and first further heating device 29 are provided on diaphragm 25. They are electrically connectible via lines and bonding pads, as is explicitly shown in FIG. 15 for the example of heating device 30 and the corresponding connection line 35 or the corresponding bonding pads 36. Heating device 30 and first further heating device 29 constitute two thermally very narrowly coupled heating resistors, which are quasi always at the same temperature. If they are positioned in opposite branches of a Wheatstone bridge, then an increased measuring signal is able to be generated which may be amplified by an amplifier.

FIG. 17 shows an evaluation electronics for a fifth example embodiment of the sensor system according to the present invention. The resistance value of heating device 30 is denoted by reference numeral 310, and the resistance value of first further heating device 29 with reference numeral 290. Together with a seventh resistor 294 and a third controllable resistor 295, the two resistance values 310, 290 of heating devices 30, 29 form a Wheatstone bridge, the tapping point situated between third controllable resistor 295 and resistance value 310 being fed to the inverting input of a third operational amplifier 602, and the tapping point situated between resistance value 290 of first further heating device 29 and seventh resistor 294 being fed to the Wheatstone bridge at the non-inverting input of third operational amplifier 602. Third operational amplifier 602 in FIG. 17 is used comparably to amplifier 60 from the evaluation electronics for the first and second example embodiments of the present invention, as depicted in FIGS. 9 and 7. In place of filter 70 illustrated in FIGS. 7 and 9 in the evaluation electronics for the first and second example embodiments of the present invention, in FIG. 17, reference numeral 71 denotes a low-pass filter, which is used to limit the band of useful signal 700, which is useful for reducing the noise component and increasing the signal-to-noise ratio. Alternatively to the use of a low-pass 71, as filter 70 in FIG. 17, a band-pass filter may also be used for filtering 70, thereby making it possible to eliminate offset voltages and slow drifts of the signal, e.g., due to temperature changes. Through the use of resistance values 310, 290 of heating devices 30, 29 in opposite branches of a Wheatstone bridge, an increased measuring signal is able to be generated, which is amplified by an amplifier 60. Using third variable resistor 295, the Wheatstone bridge may be balanced.

When using a sensor system having a plurality of heating devices 30, 29, 28, 27 on diaphragm 25, it is possible in accordance with the present invention to use one of these heating devices 27 through 30 for generating a selected temperature jump, in that this resistor is energized in pulse-like fashion. Thus, a temperature pulse is able to be generated, which may be measured using other heating devices provided as temperature-measuring means, which are situated on diaphragm 25. Thus, a self-test of sensor 1 may be carried out. The distinction between the self-test pulse and an acceleration may be made on the basis of the direction of the change in resistance. In the case of an acceleration, the resistor cools for a brief period of time, while, during a self test, a heating of short duration occurs.

It holds for all example embodiments of the present invention that the sensitivity of sensor 1 may be influenced by the use of filler gases other than air as fluid, or by the use of different filler pressures of the gas surrounding the sensor. Significant in this context is both the density of the gas used as well as its thermal capacity. The sensor may thus be adjusted for different measuring ranges.

1-7. (canceled).

8. A sensor for measuring motion of a fluid, comprising:
a heating device; and
a temperature-measuring arrangement configured to measure a temperature of a fluid as a function of a motion of the fluid at a measuring location, the measuring location being one of a location of the heating device, or an immediate vicinity of the heating device.

9. The sensor as recited in claim 8, wherein an electrical resistance of the heating device and a wiring of the heating device are provided as the temperature-measuring arrangement.

10. The sensor as recited in claim 9, wherein the wiring of the heating device is provided in such a way that the heating device is provided for operation at one of a constant current, a constant voltage, or a constant power.

11. The sensor as recited in claim 10, further comprising:
an ambient-temperature sensor, the wiring of the heating device being provided in such a way that, for operation, the heating device is provided one of: i) with a constant current with respect to measuring the motion of the fluid, ii) with a constant voltage with respect to measurement of the motion of the fluid, or iii) with a constant power with respect to the measurement of the motion of the fluid, the constant current, the constant voltage, or the constant power being provided as a function of a signal of the ambient-temperature sensor.

12. The sensor as recited in claim 8, wherein a thermocouple is provided as a temperature-measuring arrangement, the thermocouple being provided at one of the location of heating device, or immediate vicinity of the heating device.

13. The sensor as recited in claim 8, wherein the heating device includes a plurality of heating devices and the temperature measuring arrangement includes a plurality of temperature-measuring arrangements, and wherein for each of the plurality of temperature-measuring arrangements, an electrical resistance of one of the plurality of heating devices and a wiring is provided.

14. A method for measuring a motion of a fluid in relation to a heating device, comprising:
producing a temperature gradient in the fluid;
measuring, at a measuring location, the temperature of the fluid as a function of a motion of the fluid at the measuring location, using a temperature measuring arrangement;
wherein as the temperature-measuring arrangement, an electrical resistance of the heating device or a thermocouple is used, and wherein the measuring location is at a location of the heating device or an immediate vicinity of the heating device.
